(19) United States
(12) Patent Application Publication
(10) Pub. No.: US 2015/0088686 A1
(43) Pub. Date: Mar. 26, 2015

(54) System and Method for Improving the Efficiency And Security For Online Order Payment and Shipping and Tracking the Value of Social Networking Related To Same

(71) Applicant: Note Social, Inc., Parkland, FL (US)

(72) Inventors: Alexander Glassberg, Parkland, FL (US); Lorenzo Zemella, Boca Raton, FL (US); Anthony Stiesi, Boca Raton, FL (US)

(21) Appl. No.: 14/034,515

(22) Filed: Sep. 23, 2013

(51) Int. Cl. G06Q 30/06; G06Q 50/00

(52) U.S. Cl. CPC G06Q 30/0641; G06Q 30/0633; G06Q 50/01
USPC 705/26.8

(57) ABSTRACT

A method for securely and efficiently providing payment information for online purchases, posting purchase information to social media, and tracking the value of such posts through use of a hub website and an online button and blade based information selection interface.

### BACKGROUND OF THE INVENTION

This present invention relates to the field of e-commerce. More particularly, the present invention relates to a system and method for providing payment and shipping information for orders placed on merchant websites combined with the posting on social media of information relating to the purchase and the tracking of the value of such social media postings.

With the constantly increasing convenience and popularity of the Internet, online shopping has become prevalent. Many websites offer goods that can be purchased through an online checkout. Traditionally, the checkout involves the provision of both payment information, such as a credit card, bank account number or payment management site as well as billing information for the payment method and shipping information for the delivery of the purchased goods. This checkout is often a barrier for some customers, as they do not wish to provide their confidential, sensitive information, such as their credit card or bank account number on multiple sites due to security concerns. Security is a concern because of both the number of intermediate computer systems that may have access to the information while it is being transmitted and because of the storage of the sensitive information on many sites increases the likelihood that one such site will be compromised. While various encryption methods have been implemented to increase the security, there is always the possibility of such encryption being broken. Thus the minimization of the amount of confidential/sensitive information transmitted, and the maximization of confidential information stored in one place would be beneficial. It is an object of the present invention to eliminate the need for credit card or other sensitive information to be passed between the user and the merchant when making a purchase, as it is the client's connection that is of the greatest security concern. The present invention allow for the transfer of this information directly between the secure hub server and the merchant site, eliminating user browser security issues.

Another problem with online ordering is the amount of time it takes to enter payment and shipping information into a site in connection with the order. Some customers will become discouraged by the time it takes to enter all of the requested information with a purchase, and will back out of the transaction or will elect not to return to the site due to the time it takes to enter the information. The “one-click” method of checking out with pre-set information is well known in the field, and is the subject of U.S. Pat. No. 5,960,411. However, such sites require that the information be entered the first time it is used, and even on a site that has been used before, the selection of payment and shipping information can be time consuming, if a different payment method or shipping address is used from the last time the merchant site was accessed. It is an object of the present invention to allow for this step of online ordering to be expedited.

Additionally, when seeing an online ad for a product or services which a user likes, it is currently necessary for the user to click that ad, or otherwise enter an address listed on the ad, and go to the merchant webpage to complete a transaction. It is an object of the present invention to allow a user to make the purchase directly from the page featuring the ad without compromising security or efficiency. It has become popular in modern social media to “like” or otherwise post on social media merchants or purchases that are made, alerting friends and family to the purchase. Many merchants track the number of such likes or posts to represent the value of social media to their business. However, there is no proper way to value a specific “like” or post. It is an object of the present invention to allow the merchant to attach specific value to same.

### SUMMARY OF INVENTION

The present invention provides a method and system for a user to securely and efficiently select payment and shipping information for online orders on registered sites and for the merchant to track the value of social networking related to said orders. The user registers on a hub website and enters shipping addresses and payment methods for storage and later use. One shipping address and one payment method can be selected as “default.” The user also selects options on the hub website for social network posing and “liking” as well as whether a security PIN would be needed. When shopping on the site of a merchant who has also registered with the website, the user may click upon an online button which expands providing additional buttons, called blades. If the security option is turned on, the first expanded button or “blade” will require the entering of a security PIN. The other expanded buttons or “blades” provide for the selection of payment method, shipping address, social network posting and “liking” from the options entered on the website. The original button is pressed once the selection is made. If the original button is pressed a second time without selections being made, it selects the “default” address and payment method. Once the selection is made, the method will provide the shipping address and payment method to the merchant automatically, expediting the order completion. The information is sent from the hub site server to the merchant site server, avoiding user browser security risks. The receipt for the payment will automatically be stored upon the hub website, and a copy of the receipt will be sent by e-mail to the user. If the relevant options are selected, the button will also post to the selected social media that the purchase was made from the relevant merchant, and will perform the “like” action selected by the merchant upon adding the API to its website. In addition, the merchant may track the value of the social media posts and “liking” made by the button through the merchant hub.

In an alternate embodiment of the invention, the button can be found on a merchant's advertisement that appears on a webpage other than the merchant's page. In this embodiment, the button would be placed on an advertisement for a product, but would otherwise operate in the same manner as the preferred embodiment.

In an alternate embodiment of an invention, the method and system can be used to make purchases directly from receipts for offline purchases. When a user makes a purchase from an offline merchant, the merchant can send an electronic copy of the receipt directly to a user's Note account. This receipt would be stored in same location as online purchases using the preferred embodiment of this invention. The merchant can include advertisements on any electronic receipts stored in this manner, whether originating online or offline. The user could then use the method and system of this invention to make a purchase pursuant to the first alternate embodiment of this invention off an ad attached any such stored receipt.

### BRIEF DESCRIPTION OF THE DRAWINGS

FIGS. 1 is a Flow chart showing the steps by which an individual would use the method when making an order on a merchant site

FIG. 2 is a Flow Chart showing the steps would register on the hub website as the first steps of the method

FIG. 3 is a diagram illustrating an embodiment of the button of the present invention.

FIG. 4 is a flow chart showing the steps of the method for social media posting and valuation of same

FIG. 5 is a flow chart showing the steps of the method when used to make an order off of an advertisement

### DETAILED DESCRIPTION

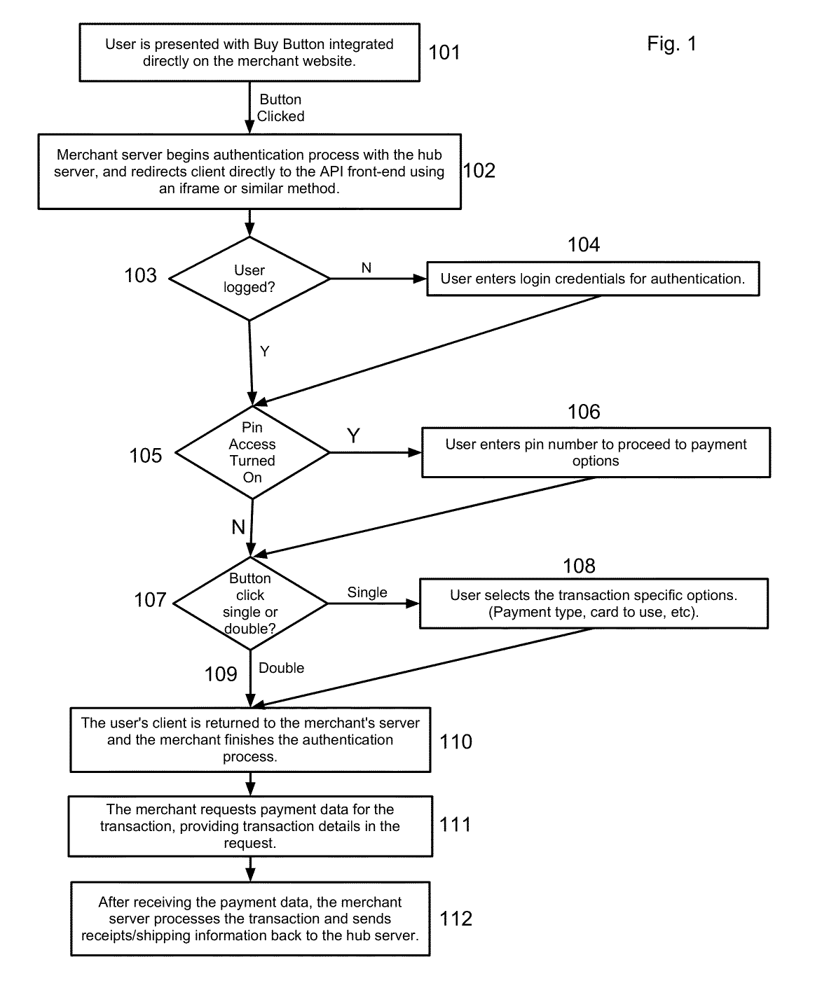

Referring now to the invention in more detail, in FIG. 1 is a flow diagram of the steps of the method when making an order on a website. When using the method in connection with making a purchase, multiple steps are involved. As shown in step 101, the Buy Button of the present invention would be integrated directly onto the merchant website. When the button is clicked, the Note API front-end is contacted (step 102) and determines if the user is logged-in (step 103). If not, the user will need to engage in step 104 and log into the Hub server. Once logged in, in step 105 the system automatically checks to determine if pin access is turned on. If pin access is turned on, the User must take step 106 and enter the Pin to proceed before proceeding to 107. Next, the user selects the payment and shipping information by following step 107 or 108. In step 107, the user clicks the buy button once. In step 108, the user will be prompted to select transactional information, such as payment method and shipping information before clicking the buy button a second time. Alternatively, the user may follow step 109, and simply double click the buy button, selecting the default payment and shipping information. In step 110, the selected payment and shipping information is transferred to the merchant site, for completion of the transaction as step 111. In step 112, the merchant site will then process the transaction and send a receipt to the Hub server.

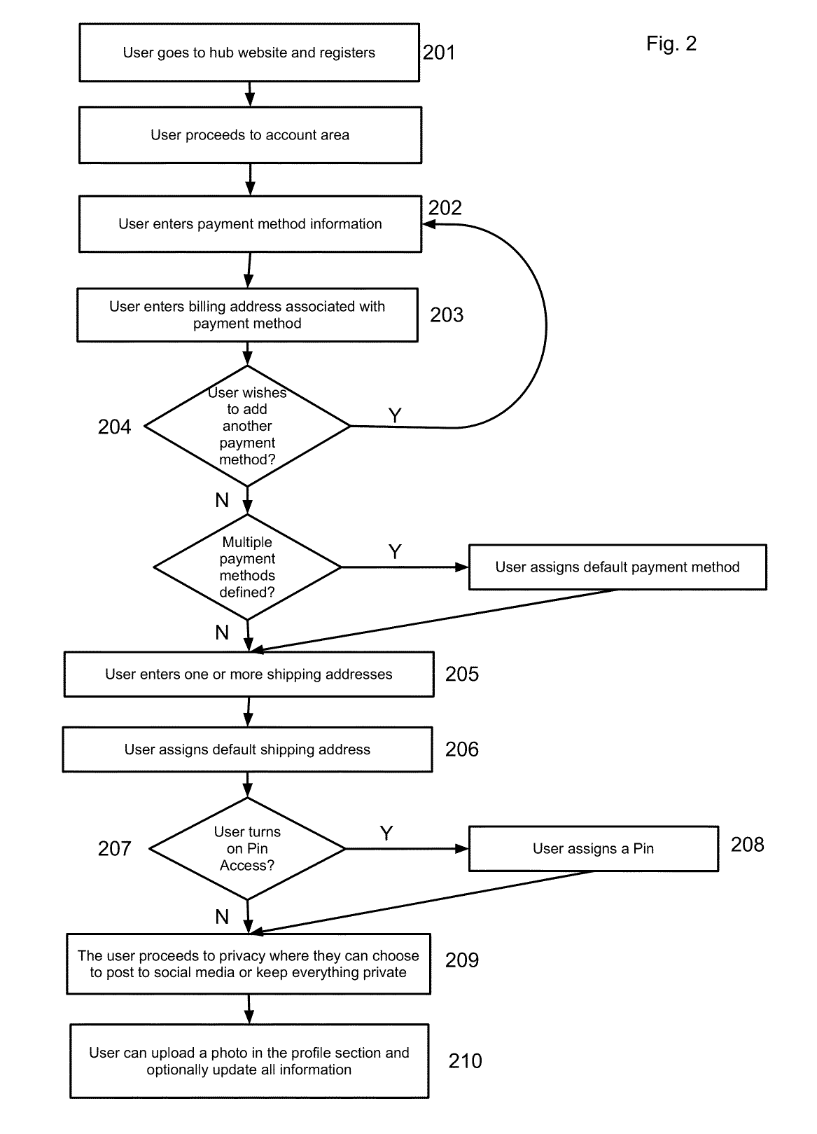

FIG. 2 shows a flow chart detailing the portion of the method occurring before the attempted purchase. In step 201, the user would go to the hub site and register with a username and password. In step 202, the user may enter one or more payment methods, and then in step 203, the user assigns billing addresses for each such payment method. If more than one payment method is entered, the user must complete step 204, and assign a default payment method. In step 205 the user may then enter one or more shipping addresses. In step 206, the user may select one shipping address as a default shipping address. In step 207, the user may elect to turn on Pin access, prompting step 208. If not, the method proceeds to step 209. In step 208 the user assigns a PIN for that will be required before the method can be used in connection with a purchase. In step 209, the user can elect settings as to whether purchase information will be posted on linked social media. In step 210, the user may upload a photo and edit personal information to be associated with the account.

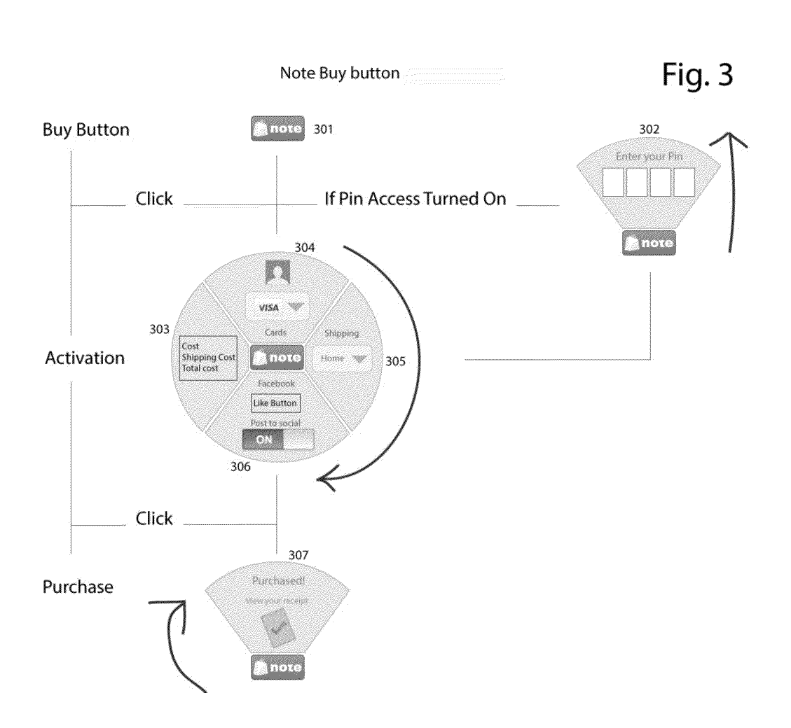

FIG. 3 shows an illustration of the preferred interface for the buy button. The central button 301 will appear on the merchant website. When pressed, the button will check whether PIN security is activated. If required, the PIN blade 302 will expand out from the buy button 301. If PIN security is not activated, or after the PIN is entered, additional blades will expand from the buy button 301, including cost summary blade 303, payment method selection blade 304, shipping address selection blade 305 and social media posting button 306. Upon a second pressing of the buy button, the purchase will be completed, and confirmation blade 307 will replace the blades 303, 304, 305, and 306. The user may click confirmation blade 307 to return to the hub website and review the receipt of the transaction.

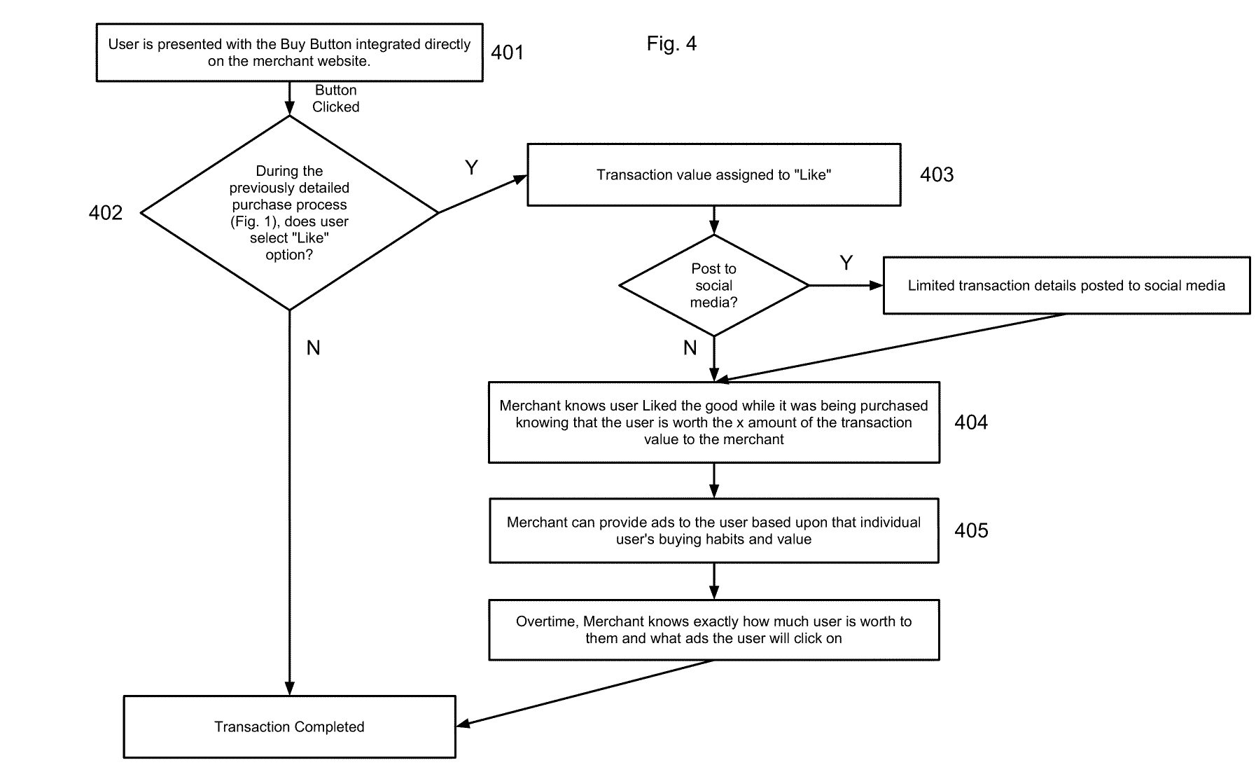

FIG. 4 shows a flow chart of the portion of the method wherein the user selects “like” on the social media button 306 of FIG. 3 or where the social media selection 209 of FIG. 2 is set to always “like” a purchase. In step 401, the user completes a purchase using the buy button of the present invention. In step 402, the button will post the appropriate social media posting to the linked social media. Simultaneously, the system will perform step 403, and will record the value of the transaction and assign it to the record of the social media posting. In step 404, the merchant may access the hub site and review the values assigned to social media postings. The merchant can use this information to perform step 405 and attach a targeted ad to the user.

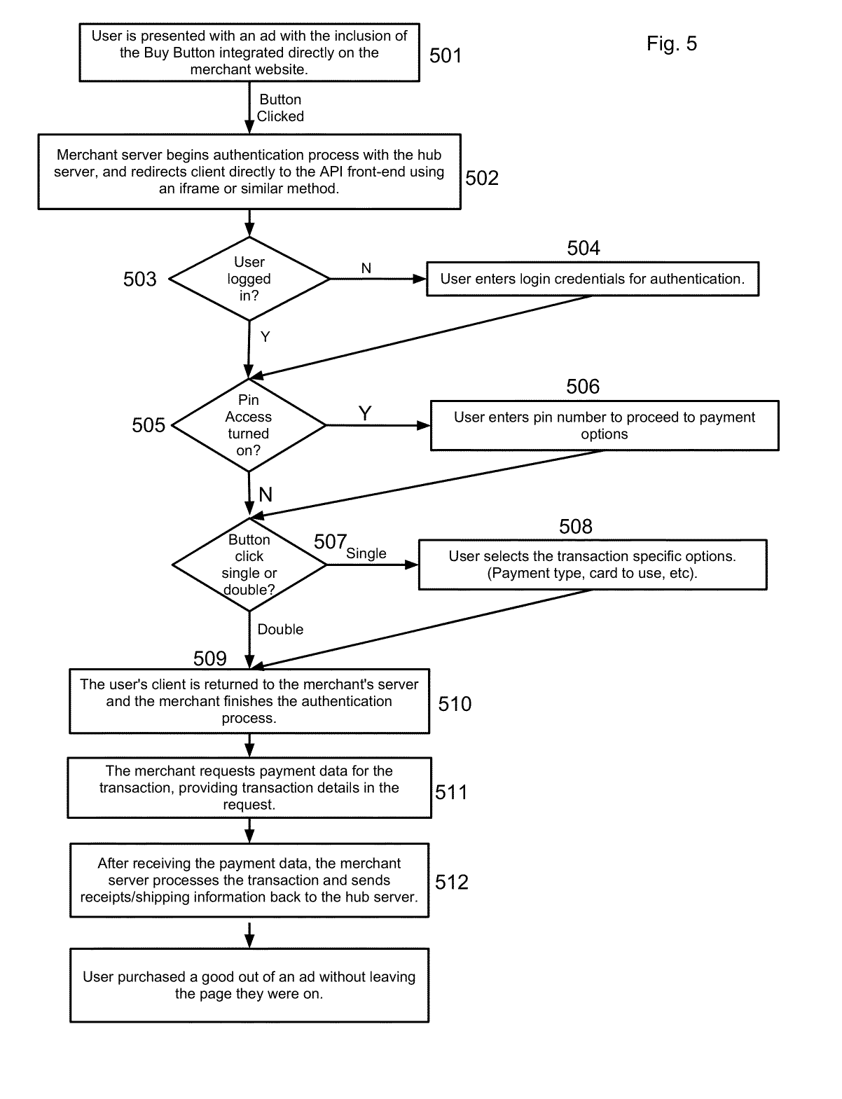

FIG. 5 shows a flow chart indicating the steps by which an individual would use the method when making an order directly from an ad linked to the merchant's website. This method allows the user to make the purchase without leaving the page upon which the ad was seen. As shown in step 501, the Buy Button of the present invention would be integrated directly onto the merchant ad. IN step 502, the merchant server will perform a behind the scenes redirection to the Note API front-end. In step 503, the system will determine if the user is logged into the hub server. If so, the system will pass to step 505. If not, the user will have to perform step 504, and log into the hub server before proceeding to step 505. IN step 505 the system checks to determine if pin access is turned on for the user's account. If it is turned on, the user proceeds to stop 506, but if not, the user proceeds to step 507. In step 506, the user must enter the correct PIN to proceed to step 507. Next, the user selects the payment and shipping information by following step 507 or 508. In step 507, the user clicks the buy button once. In step 508, the user will be prompted to select transactional information, such as payment method and shipping information before clicking the buy button a second time. In step 509, the user clicks the buy button a second time, selecting the default payment and shipping information. In step 510, the selected payment and shipping information is transferred to the merchant site, for completion of the transaction as step 511. In step 512, the merchant site will then process the transaction and send a receipt to the Hub server.

The advantages of the present invention include, without limitation, providing users with secure and centralized means for storing payment and shipping information for use for a multitude of online sites without having to register for each one; a centralized storage for all receipts from such transactions; a secure means of providing payment information to a merchant, convenient social network posting of online transactions and the tracking and valuation of such social media postings by the merchant to allow for targeted advertising.

While the foregoing written description of the invention enables one of ordinary skill to make and use what is considered presently to be the best mode thereof, those of ordinary skill will understand and appreciate the existence of variations, combinations, and equivalents of the specific embodiment, method and examples herein. The invention should not be limited by the above described embodiment, method and examples, but by all embodiments and methods within the scope and spirit of the invention.

I claim:

1. A method of providing payment and shipping information for purchases made online comprising:
On a hub server,
a customer entering one or more payment methods the customer entering one or more shipping addresses;
On a merchant website,
a first display component,
the customer clicking the first display component initiating contact with the hub server,
The first display component expanding when clicked to reveal a second display component allowing selection between payment methods entered on the hub server and a third display component allowing selection between the shipping addresses entered onto the hub server.
the customer selecting a shipping address and payment method using the second display component and third display component;
the consumer clicking the first display component a second time to transmit the selected payment method and shipping address securely from the hub server to the merchant site

2. A method of claim 1 wherein the customer enters social media posting options on the hub server, the first display component on the merchant site also expands when clicked to reveal a fourth display component that allows for social media posting of a consumer transaction made using this method; the consumer selects social media posting options using the fourth display component; and the social media posting is performed when the first display component is clicked a second time.

3. A method of claim 2 wherein the hub server assigns value to the social media posting options selected using the fourth display component

4. A system for securely providing payment and shipping information for purchases made online comprising:
A hub server for storing payment methods and shipping addresses for a customer,
A first display component on a merchant website,
At least a second and third display component revealed when the customer clicks on said first display component once, said second display component allowing for selection between payment method stored on the hub server and said third display component allowing for selection between shipping addresses stored on said hub server;
Secure transmission component that transmits the selected payment method and shipping information from the hub server to the merchant site when the customer clicks the first display component a second time
